(19) United States
(12) Patent Application Publication
(10) Pub. No.: US 2011/0135920 A1
(43) Pub. Date: Jun. 9, 2011

(54) SLIDING MEMBER

(75) Inventor: Toshimitsu TACHIBANA, Osaka (JP)

(73) Assignee: NITTO DENKO CORPORATION, Osaka (JP)

(21) Appl. No.: 12/961,632

(22) Filed: Dec. 7, 2010

(30) Foreign Application Priority Data
Dec. 8, 2009 (JP) 2009-278432

(51) Int. Cl. B32B 7/00

(52) U.S. Cl. 428/354

(57) ABSTRACT

The present invention relates to a sliding member including: a sheet-shaped slidable substrate; a dimension-retaining layer bonded to one main surface of the slidable substrate; and an adhesive layer or a pressure-sensitive adhesive layer formed on the dimension-retaining layer, in which the dimension-retaining layer has a tensile modulus of 2 GPa or higher.

### FIELD OF THE INVENTION

The present invention relates to a sliding member. More particularly, the invention relates to a sliding member for use in image-forming apparatus, e.g., copiers, recording media which rotate when operated, such as CDs (compact disks) and DVDs (digital versatile disks), and recording/reproducing apparatus for such recording media.

### BACKGROUND OF THE INVENTION

A member having excellent sliding properties (hereinafter referred to as “sliding member”) has hitherto been used in the paper feeding part of an image-forming apparatus such as a copier for the purpose of stably feeding paper to the image-forming part. Namely, in order to prevent stable paper feeding from being inhibited by the friction caused by contact between the paper and a component of the apparatus, a sliding member is disposed between the paper and the component. Meanwhile, sliding members are disposed also in recording media which rotate when operated (CDs, DVDs, etc.) and in recording/reproducing apparatus which record information in such recording media and reproduce the information. For example, there are cases where in order to prevent a recording medium housed in a case from coming into contact with the case upon rotation thereby being damaged, a sliding member is interposed between the recording medium and the case (see patent document 1). There also are cases where a sliding member is disposed between a recording medium and a component (e.g., optical head) of a recording/reproducing apparatus for the purpose of preventing the recording medium from coming into contact with the component, when rotated, thereby being damaged (see patent document 2).

As sliding members, low-friction plastics such as polytetrafluoroethylene (hereinafter referred to as “PTFE”) and ultrahigh molecular weight polyethylene (hereinafter referred to as “UHMWPE”) are generally used. In particular, it is well known to use porous materials made of these plastics. Patent document 3 discloses a sliding member including a slidable substrate constituted of a porous film consisting mainly of a plastic, a pressure-sensitive adhesive layer, and a barrier layer disposed between the slidable substrate and the pressure-sensitive adhesive layer. This barrier layer has been disposed in order to inhibit the pressure-sensitive adhesive from moving from the pressure-sensitive adhesive layer to the slidable substrate, and a thermoplastic resin such as polyethylene or polypropylene is used as the barrier layer.

However, as a result of the trend toward size and weight reductions in electronic appliances including image-forming apparatus and recording/reproducing apparatus, constituent members of these appliances are coming to be required to have higher dimensional accuracy besides a smaller size and a complicated shape. Under such circumstances, sliding members also are increasingly desired to satisfy the same requirements and are coming to be required to have a smaller size (reduced thickness) and high dimensional accuracy. In the case where a conventional sliding member by itself is applied in a reduced thickness, the material itself constituting the sliding member has reduced strength. Because of this, when this sliding member is subjected to consecutive punching with a die while applying tension to the material, there are cases where the material is processed in a stretched state. This processing is apt to result in a problem that sliding members satisfying the desired high dimensional accuracy are not obtained. In addition, such processing is apt to pose a problem that the residual stress resulting from the processing exerts an influence also on dimensional changes with the lapse of time to reduce dimensional stability.
Patent Document 1: JP-A-2001-148175
Patent Document 2: JP-A-2007-265572
Patent Document 3: JP-A-2004-310943

### SUMMARY OF THE INVENTION

The present invention has been achieved in view of those problem, and an object thereof is to provide a sliding member which, even when produced in a reduced thickness, can be processed with high dimensional accuracy and which changes little in dimension with the lapse of time.

The present inventors diligently made investigations and, as a result, have found that the problems described above can be overcome by employing the following configuration. The invention has been thus achieved.

Accordingly, the present invention relates to the following items (1) and (2).

(1) A sliding member including:

a sheet-shaped slidable substrate;

a dimension-retaining layer bonded to one main surface of the slidable substrate; and

an adhesive layer or a pressure-sensitive adhesive layer formed on the dimension-retaining layer,

in which the dimension-retaining layer has a tensile modulus of 2 GPa or higher.

(2) The sliding member according to (1), in which the slidable substrate includes a porous film of ultrahigh molecular weight polyethylene.

Since a dimension-retaining layer having a tensile modulus of 2 GPa or higher has been formed in the sliding member of the invention, the constituent materials of the sliding member are less apt to be deformed (stretched) by the tension applied thereto during processing. As a result, a sliding member capable of being processed with high dimensional accuracy even when produced in a reduced thickness can be realized. Furthermore, even when stress remains in the sliding member due to the tension or the like applied thereto during processing, the expansion or contraction accompanying the residual stress can be corrected by such a dimension-retaining layer. Consequently, it is also possible to inhibit the sliding member from dimensionally changing with the lapse of time.

### BRIEF DESCRIPTION OF THE DRAWING

FIG. 1 is a sectional view illustrating the configuration of a sliding member of the invention.

### DETAILED DESCRIPTION OF THE INVENTION

Embodiments of the sliding member of the invention are explained below. However, the following description should not be construed as limiting the scope of the invention.

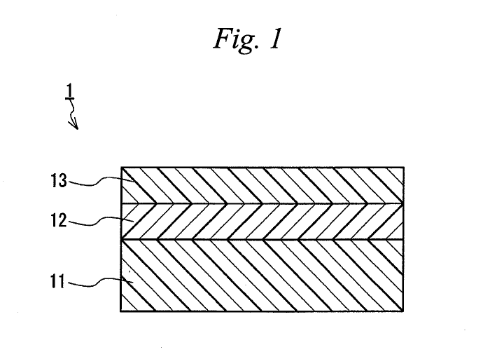

As shown in FIG. 1, the sliding member 1 as one embodiment includes a sheet-shaped slidable substrate 11, a dimension-retaining layer 12 bonded to one main surface of the slidable substrate 11, and an adhesive layer (or pressure-sensitive adhesive layer) 13 formed on the dimension-retaining layer 12.

When the sliding member 1 is attached to a certain component, the sliding member 1 is disposed so that the slidable substrate 11 faces other components with which that component may come into contact. Therefore, a material having excellent sliding properties is used as the slidable substrate 11. For example, it is preferred that the slidable substrate 11 should be constituted of a porous UHMWPE film. This is because the porous UHMWPE film is a porous film formed from UHMWPE, which has a low coefficient of friction, and hence has a low coefficient of friction and excellent sliding properties. The term “UHMWPE” means polyethylene having an average molecular weight of 500,000 or higher. In this embodiment, it is preferred that a porous UHMWPE film produced using polyethylene having an average molecular weight of 1,000,000 or higher as a raw material should be used in order to obtain a sliding member having excellent wear resistance. Commercial products of such UHMWPE include, for example, “Hizex Million (registered trademark)” (manufactured by Mitsui Chemicals, Inc.), “Hostalen GUR (trade name)” (manufactured by Ticona), and “SUNFINE (registered trademark)” (manufactured by Asahi Kasei Chemicals Corp.). The molecular weight of UHMWPE herein is a viscometric measured value. Although a porous UHMWPE film is used as the slidable substrate 11 in this embodiment explained here, the slidable substrate 11 should not be construed as being limited to the porous film. Also usable as the slidable substrate 11 are non-porous sheets made of UHMWPE, which has excellent sliding properties, fluororesin sheets made of PTFE, a tetrafluoroethylene/perfluoroalkyl vinyl ether copolymer (PFA), a tetrafluoroethylene/hexafluoropropylene copolymer (FEP), an ethylene/tetrafluoroethylene copolymer (ETFE), or the like, these sheets to which a filler has been added, polyolefin sheets made of polyethylene, polypropylene, or the like, sheets obtained by forming surface irregularities in these fluororesin sheets and polyolefin sheets, etc.

The porous UHMWPE film can be produced, for example, by the sintering method disclosed in JP-B-5-66855 or the coating method disclosed in JPA-2007-229943.

The thickness of the slidable substrate 11 is not particularly limited, and can be suitable designed according to applications. However, the thickness thereof is preferably 0.05 mm or larger and 0.5 mm or smaller. In the case where the thickness thereof is smaller than 0.05 mm, this slidable substrate 11 has considerably reduced strength and is apt to deform or break when combined with (adhered to) the dimension-retaining layer 12. On the other hand, in the case where the thickness thereof exceeds 0.5 mm, the slidable substrate 11, which is a porous material, is apt to deform in the thickness direction due to the stress applied thereto during cutting when the sliding member is processed. There are hence cases where this sliding member has reduced dimensional accuracy in processing. Furthermore, superposition of other layers thereon results in too large a thickness of the sliding member 1 as a whole, making it difficult to attain a thickness reduction.

The porosity of the slidable substrate 11 is preferably in the range of 20 to 70%, more preferably in the range of 25 to 50%. In the case where the porosity thereof is lower than 20%, this slidable substrate 11 has an increased coefficient of friction. On the other hand, in the case where the porosity thereof exceeds 70%, this sheet has reduced strength and has weakened binding between the UHMWPE particles. There are hence cases where such too high a porosity causes a trouble that after this sliding member is attached to a product, UHMWPE particles drop-off therefrom. The porosity of the slidable substrate 11 can be determined by calculating the apparent volume V (cm³) from the product of the surface area and thickness of the slidable substrate 11 and calculating the porosity from the weight W (g) of the slidable substrate 11 and the true specific gravity p of the material constituting the slidable substrate 11 using the following equation.

Porosity (%)=(1−W/V/ρ)×100

Antistatic performance and satisfactory slip properties may be further imparted as additional functions to the slidable substrate 11. In the case of imparting antistatic performance, use can be made, for example, of a method in which a surfactant or a conductive polymer is applied to the surface of the slidable substrate 11 or a method in which carbon black is mixed with raw materials when the slidable substrate 11 is formed. In the case where satisfactory slip properties are to be imparted, use can be made, for example, of a method in which a lubricant such as a silicone is applied to the surface of the slidable substrate 11.

As the dimension-retaining layer 12, a sheet having a tensile modulus of 2 GPa or higher is used. The tensile modulus of the dimension-retaining layer 12 is a value measured by the measuring method in accordance with JIS K 7113 (test piece: No. 2 test piece; tension rate, 10 mm/min). Examples of the material thereof include plastic films such as poly(ethylene terephthalate) (PET), poly(butylene terephthalate) (PBT), polyimides (PI), and polyetheretherketones (PEEK) and metal foils such as aluminum foils. In the case where the tensile modulus of the dimension-retaining layer 12 is too high, this renders the sliding member 1 excessively rigid and there are cases where such excessive rigidity causes a trouble, for example, that when the sliding member 1 is processed with a die, the processing is difficult or the life of the die is shortened. Consequently, the tensile modulus of the dimension-retaining layer 12 is preferably 30 GPa or lower, more preferably 20 GPa or lower.

The thickness of the dimension-retaining layer 12 depends also on the material used. In the case of a plastic film, the thickness thereof is preferably 10 μm or more and 300 μm or less, more preferably 20 μm or more and 200 μm or less. In the case of a metal foil, the thickness thereof is preferably 5 μm or more and 150 μm or less, more preferably 10 μm or more and 100 μm or less. In the case where the thickness thereof is smaller than the lower limit of the range specified above, it is difficult to maintain strength necessary for retaining the dimensions. There are hence cases where a deformation is apt to occur due to tension. In the case where the thickness of the dimension-retaining layer 12 exceeds the upper limit of the range specified above, this material has too high rigidity and there are cases where processing of the sliding member is apt to cause a trouble.

The slidable substrate 11 and the dimension-retaining layer 12 are bonded to each other with an adhesive layer or a pressure-sensitive adhesive layer. Examples of the adhesive contained in the adhesive layer include hot-melt adhesives including an EVA (ethylene/vinyl acetate copolymer), polyolefin, synthetic rubber, or the like as the main component. Examples of the pressure-sensitive adhesive contained in the pressure-sensitive adhesive layer include general pressure-sensitive adhesives such as the acrylic, rubber-based and silicone-based pressure-sensitive adhesives.

The adhesive layer 13 is a layer to be used for fixing the sliding member 1 to the adherend surface of a component to which the sliding member 1 is to be attached. As the adhesive contained in the adhesive layer 13, use may be made of a hot-melt adhesive including an EVA, polyolefin, synthetic rubber, or the like as the main component. In the case where a pressure-sensitive adhesive layer is used in place of the adhesive layer 13, use can be made of a general pressure-sensitive adhesive such as the acrylic, rubber-based, or silicone-based pressure-sensitive adhesives.

For producing the sliding member 1, a process in which a dimension-retaining layer 12 is bonded to a surface of a slidable substrate 11 with an adhesive or pressure-sensitive adhesive, and an adhesive layer (or pressure-sensitive adhesive layer) 13 is formed thereon may be mentioned. Alternatively, a double-coated tape employing, for example, a PET film as the substrate can be utilized to produce a sliding member 1 by applying this double-coated tape to a surface of a slidable substrate 11. This method utilizing such a double-coated tape brings about an effect that the number of steps for bonding layers can be reduced. Furthermore, the reduced number of bonding steps bring about an effect that the residual stress resulting from the tension applied during bonding is less apt to exert an influence. It should, however, be noted that when such a double-coated tape is utilized, it is necessary to select a double-coated tape in which the PET film as the substrate has a tensile modulus of 2 GPa or higher, because this PET film serves as the dimension-retaining layer.

The slidable substrate 11 and the dimension-retaining layer 12 made of a plastic material may be subjected to a surface modification treatment such as a corona discharge treatment, plasma treatment, or sputtering in order to improve adhesiveness to adhesives or pressure-sensitive adhesives.

### EXAMPLES

### Example 1

A UHMWPE powder (average molecular weight: 5,000,000; bulk density: 0.47 g/cm³; average particle diameter: 120 μm) was packed into a mold having an inner diameter of 500 mm and a height of 500 mm. This mold was placed in a metallic pressure vessel, which was evacuated to 1,000 Pa. Thereafter, heated water vapor was introduced thereinto to heat the mold at 160° C. for 5 hours at 0.6 MPa (6 atm), and the mold was then gradually cooled to obtain a cylindrical sintered porous object. This sintered porous object was cut with a lathe to obtain a sheet having a thickness of 0.2 mm. This sheet was used as a slidable substrate.

Double-coated tape “No. 5610” (manufactured by Nitto Denko Corp.) was used as a dimension-retaining layer and an adhesive layer (or a pressure-sensitive adhesive layer). This double-coated tape has a PET film as the substrate. The tensile modulus of the PET film employed in the double-coated tape was determined by the method in accordance with JIS K7127 and, as a result, was found to be 2.5 GPa. The measurement of the tensile modulus was made after the pressure-sensitive adhesive of the double-coated tape had been removed. Namely, the tensile modulus of the substrate film of the double-coated tape was determined. Specifically, an operation including immersing the double-coated tape in toluene for 4 hours, subsequently removing the pressure-sensitive adhesive layers of the double-coated tape with a waste cloth, and then drying the tape, was conducted twice to obtain the substrate film of the double-coated tape.

The porous UHMWPE film and double-coated tape thus prepared were laminated to each other by passing a stack thereof at a rate of 0.5 m/min through the nip between a pair of rubber rolls heated at 60° C.

The sliding member of Example 1 obtained by the method described above was evaluated for dimensional stability. The valuation method is as follows. First, a roll of a sheet having a width of 150 mm and a length of 20 m was produced and then subjected to punching to cut out 50 square pieces having dimensions of 100 mm×100 mm. These square pieces were examined for dimensions just after the punching and for dimensions after a heat treatment (60° C., 24 hours). Table 1 shows the average, minimum, and maximum values of dimensions obtained through a measurement with a projector (minimum scale, 0.01 mm), with respect to each of the longitudinal-direction dimension and the width-direction dimension. In Table 1, each minimum value and each maximum value are each given in terms of deviation from the corresponding average value.

### Comparative Example 1

A sliding member of Comparative Example 1 was produced in the same manner as in Example 1, except that the dimension-retaining layer was omitted and double-coated tape “No. 500” (manufactured by Nitto Denko Corp.) was used as an adhesive layer (or pressure-sensitive adhesive layer). This sliding member of Comparative Example 1 also was evaluated for dimensional stability in the same manner as in Example 1. The results thereof are shown in Table 1.

### Comparative Example 2

A thermal laminator was used to thermally laminate “Admer VE300” (manufactured by Mitsui Chemicals, Inc.), which was a polyolefin-based hot-melt material, as a dimension-retaining layer to a slidable substrate prepared in the same manner as in Example 1, under the conditions of 130° C. for 120 seconds. Double-coated tape “No. 500” (manufactured by Nitto Denko Corp.) was further applied thereto as an adhesive layer (or pressure-sensitive adhesive layer). The tensile modulus of the “Admer VE300” used here was determined by the method in accordance with JIS K7127 and, as a result, was found to be 0.5 GPa. This sliding member of Comparative Example 2 also was evaluated for dimensional stability in the same manner as in Example 1. The results thereof are shown in Table 1.

TABLE 1

| Just after processing | | | After heat treatment | | |
|---|---|---|---|---|---|
| Average | Minimum | Maximum | Average | Minimum | Maximum |
| value (mm) | value (mm) | value (mm) | value (mm) | value (mm) | value (mm) |

<Longitudinal Direction>

| | | | | | | |
|---|---|---|---|---|---|---|
| Example 1 | 100.01 | −0.05 | +0.05 | 99.74 | −0.15 | +0.17 |
| Comparative | 100.04 | −0.12 | +0.08 | 98.83 | −0.48 | +0.41 |
| Example 1 | | | | | | |
| Comparative | 100.03 | −0.12 | +0.13 | 99.07 | −0.42 | +0.44 |
| Example 2 | | | | | | |

<Width Direction>

| | | | | | | |
|---|---|---|---|---|---|---|
| Example 1 | 100.02 | −0.06 | +0.05 | 100.26 | −0.12 | +0.14 |
| Comparative | 100.10 | −0.12 | +0.11 | 101.04 | −0.45 | +0.40 |
| Example 1 | | | | | | |
| Comparative | 100.13 | −0.15 | +0.12 | 100.91 | −0.39 | +0.40 |
| Example 2 | | | | | | |

It was ascertained from the results given in Table 1 that with respect to dimensions just after processing, the average values for the sliding member of Example 1 were closer to the target dimension and the differences between the maximum and the minimum values were smaller as compared with the sliding members of the Comparative Examples. The following was further ascertained. The heat treatment caused the sliding member of each of Example 1 and the Comparative Examples to undergo dimensional changes. However, the sliding member of Example 1 was inhibited from undergoing the dimensional changes attributable to the residual stress remaining after the substrate formation stage or laminating stage, by the dimension-retaining layer satisfying a tensile modulus of 2 GPa or higher. The sliding member of Example 1 hence showed the smallest dimensional changes and had excellent dimensional stability.

It was ascertained from the results given above that due to the disposition of a dimension-retaining layer satisfying a tensile modulus of 2 GPa or higher, a sliding member which can be processed with high dimensional accuracy even when produced in a reduced thickness and which changes little in dimension with the lapse of time can be obtained.

While the invention has been described in detail with reference to specific embodiments thereof, it will be apparent to one skilled in the art that various changes and modifications can be made therein without departing from the spirit and scope thereof.

Incidentally, the present application is based on Japanese Patent Application No. 2009-278432 filed on Dec. 8, 2009, and the contents are incorporated herein by reference.

All references cited herein are incorporated by reference herein in their entirety.

Also, all the references cited herein are incorporated as a whole.

The sliding member of the invention has excellent dimensional stability and, hence, can be formed even into smaller complicated shapes with high dimensional accuracy. Consequently, the sliding member of the invention is applicable also to apparatus required to have higher dimensional accuracy, such as electronic appliances including compact and lightweight image-forming apparatus and recording/reproducing apparatus, etc.

### DESCRIPTION OF REFERENCE NUMERALS

1 Sliding member
11 Slidable substrate
12 Dimension-retaining layer
13 Adhesive layer (pressure-sensitive adhesive layer)

What is claimed is:

1. A sliding member comprising:
a sheet-shaped slidable substrate;
a dimension-retaining layer bonded to one main surface of the slidable substrate; and
an adhesive layer or a pressure-sensitive adhesive layer formed on the dimension-retaining layer,
wherein the dimension-retaining layer has a tensile modulus of 2 GPa or higher.

2. The sliding member according to claim 1, wherein the slidable substrate comprises a porous film of ultrahigh molecular weight polyethylene.
